(19) United States
(12) Patent Application Publication
(10) Pub. No.: US 2007/0123208 A1
(43) Pub. Date: May 31, 2007

(54) System and method for prioritizing emergency communications in a wireless network

(76) Inventors: Puneet Batta, Santa Clara, CA (US); Aseem Sethi, Bangalore (IN); Amit Phadnis, Bangalore (IN)

Correspondence Address: FAY KAPLUN & MARCIN, LLP, 15O BROADWAY, SUITE 702, NEW YORK, NY, 10038, US

(21) Appl. No.: 11/287,862

(22) Filed: Nov. 28, 2005

(51) Int. Cl. H04M 11/04

(52) U.S. Cl. 455/404.1; 455/411

(57) ABSTRACT

Described is a method which includes receiving an association request from a first wireless device to establish an emergency connection via a wireless communications network. A wireless bandwidth availability required to grant the request is analyzed. When the bandwidth is unavailable, a wireless connection between a second wireless device and the wireless network is terminated and the request of the first device is granted.

### BACKGROUND INFORMATION

Gaining access to a wireless network traditionally requires authentication of a mobile unit (“MU”) by an access point (“AP”) coupled to the network. The authentication typically involves an exchange of signals between the MU and the AP (i.e., a handshake) and is granted or denied based on the content of the signals. The authentication may present a problem with respect to placing an emergency call over the wireless network. For example, the MU may be required to have knowledge of an encryption key which is used on the network. Without the key, the MU may be denied access to the network. This may consume time which may be instrumental in saving a life or responding to the emergency.

Another major problem which may be encountered in placing emergency calls relates to an availability of bandwidth even after the authentication is successful. For example, the AP may be serving a maximum number of MUs. Therefore, another MU which attempts to place a call will be denied. Because there is no way to differentiate the emergency call from another type of call, the MU attempting the emergency call may be forced to wait until enough bandwidth becomes available. Again, this added time may be critical in an emergency.

### SUMMARY OF THE INVENTION

The present invention relates to a method which includes receiving an association request from a first wireless device to establish an emergency connection via a wireless communications network. A wireless bandwidth availability required to grant the request is analyzed. When the bandwidth is unavailable, a wireless connection between a second wireless device and the wireless network is terminated and the request of the first device is granted.

### BRIEF DESCRIPTION OF THE DRAWINGS

FIG. 1 is an exemplary embodiment of a system according to the present invention;

FIG. 2 is an exemplary embodiment of a method according to the present invention; and

### DETAILED DESCRIPTION

The present invention may be further understood with reference to the following description and the appended drawings, wherein like elements are provided with the same reference numerals. The present invention provides a system and a method for providing priority to a wireless communication in a wireless network. For example, in an event of an emergency, a MU may immediately connect to a wireless network, bypassing authentication and without regard to a current throughput of the network.

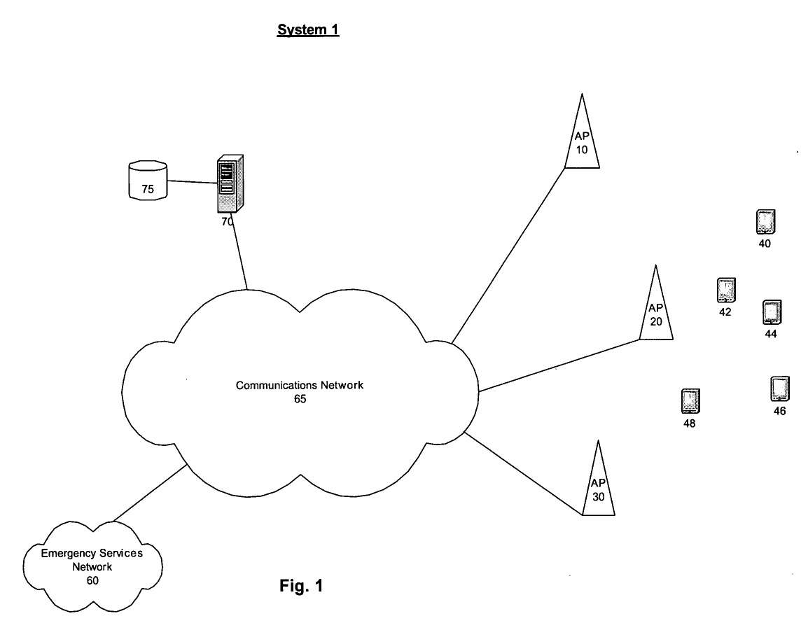

FIG. 1 shows a system 1, wherein several access points (“APs”) 10, 20, 30 are coupled to a communications network 65 and may support connections for one or more mobile units (“MUs”) 40-48 thereto. That is, the MUs 40-48 may transmit and receive signals to/from an AP (e.g., the AP 20) and thereby communicate with the network 65. The system 1 may further include a server 70 and a database 75. The APs 10-30 may be coupled to a network management arrangement (e.g, a switch). Each MUs 40-48 may include at least one of an image-based scanner, a laser-based scanner, an RFID reader, an RFID tag, a PDA, a wired network interface card, a wireless network interface card, a wireless VoIP phone and a converged network device.

As shown, the system 1 may also include an Emergency Services Network (“ESN”) 60 which may include a communication device (e.g., a telephone, a computer, a PDA, etc.) used by an emergency services operator/dispatcher. In another embodiment, the ESN 60 may comprise a server and one or more communication devices connected thereto. The communication devices may be employed to receive emergency calls placed through the communications network 65 and/or to dispatch service units to a location as necessary.

In a conventional wireless network, a MU first associates with the AP by transmitting an association request to the AP and receiving a response therefrom. The AP's response may indicate that association is granted or that it is denied. In some instances, association may further include an authentication procedure. In this procedure, the MU may be required to transmit a correct identifier and password (e.g., encryption keys), which may be confirmed by the AP and/or another network entity.

Although an AP may be capable of supporting several MUs at a time, the AP may reach a maximum capacity. For example, APs on an 802.11 network have a maximum bandwidth of 54 Mbps. Thus, if the MUs associated therewith are consuming the entire 54 Mbps, no further MUs may associate with the AP. Even if the MUs associated with an AP are consuming most, but not all, of its available bandwidth, the AP may be unable to support an additional MU.

The above described association/authentication and/or the limited bandwidth of an AP may present problems for MUs attempting to connect to the network. For example, an MU may be prevented from associating with an AP if it supplies an incorrect identifier or password, or if the AP is operating at or near its maximum capacity. These problems are unacceptable in emergency situations, wherein time is of the essence.

According to the present invention, an MU attempting to access a network may receive priority over other MUs. For example, an AP may detect that a particular call is an emergency call, and thus may immediately permit association. In one embodiment, the AP grants an association request without insisting on completion of the authentication procedure. In another embodiment, the AP may discontinue support of an MU which is connected to the network in order to free enough bandwidth to support the emergency call. In yet another embodiment of the present invention, the AP may redirect traffic received from the MU to a separate virtual local area network (“VLAN”). In another embodiment, the AP redirects traffic to a voice gateway which only permits emergency calls (i.e., calls addressed to the ESN 60) to be completed.

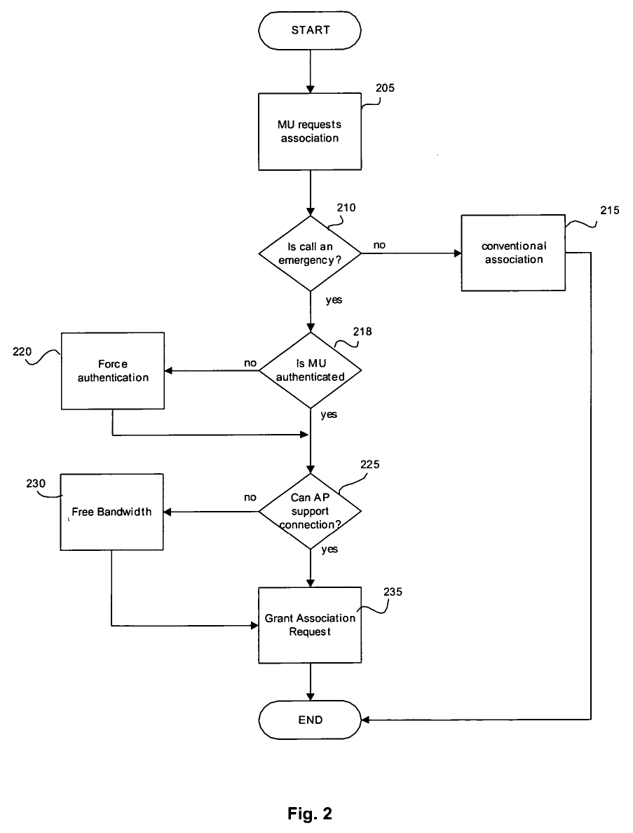

FIG. 2 shows a method 200 for supporting an emergency call on a wireless network. The method 200 will be described with reference to the system 1 of FIG. 1. However, those skilled in the art will understand that other systems having varying configurations, for example different number of MUs, APs, and other wireless networks, for example general packet radio service (“GPRS”) networks may be used to execute the exemplary method 200. A person skilled in the art will also understand that the emergency call may take various forms. For example, it may be an emergency broadcast to an organization's network, a VoIP ‘911’ call, a cellular ‘911’ call, or even an urgent email that needs to be sent out immediately.

In step 205, an MU (e.g., the MU 40) requests association. Accordingly, the MU 40 may send an association request to the AP 20. The association request may be a data frame which includes information pertaining to the MU 40. For example, the frame may include a medium access control (“MAC”) address of the MU 40, and any authentication information. According to an embodiment of the present invention, the association request frame may further include an indication of an emergency situation. For example, the frame may include an “Emergency” field, in which a bit may be set to “1” in case of emergency and “0” for a non-emergency transmission. The bit may be set manually or automatically, for example, when dialing “911.” More bits could be used to indicate different degrees of urgency. According to another embodiment of the present invention, the association request frame may similarly include a priority request field. Thus, if multiple MUs are attempting to associate with the AP 50 simultaneously, the AP 50 can give priority to the association packet that contains the signal that the MU is making an urgent call, and allow that MU to associate first.

In step 210, the AP 20 determines if the call is an emergency. As mentioned above, an emergency status of a call may be indicated in a field of the association request frame. If the call is not an emergency, it is handled according to conventional association procedures (step 215). For example, the MU 40 may supply appropriate authentication information and may associate subject to an amount of bandwidth available at the AP 20.

If the call is determined to be an emergency in step 210, certain exceptions and/or modifications may be made in order to allow completion of the call in a most timely manner. A first of these exceptions may occur if it is determined in step 218 that the MU is not authenticated. The MU may not be able to authenticate for at least several reasons, including a lack of proper authentication credentials (e.g., encryption keys, etc.) Because the call is an emergency, the AP 20 may force association of the MU 40 (step 220). For example, the AP 20 may override or ignore network settings/requirements (e.g., encryption type, frame format, authentication information, etc). Thus, for purposes of association, the MU 40 may be considered to have automatically authenticated.

Although the authentication process is shown as occurring in step 220, it will be understood by those of skill in the art that the process may occur at any point. For example, in some systems the MU 40 may be authenticated after it has associated with the AP 20, but before it has established a connection to the network 65. Further, in one embodiment of the present invention, association of an MU may be automatically forced upon receipt of a frame indicating an emergency. Thus, step 218 may be considered optional.

In step 225, it is determined whether the AP 20 can support connection of the MU 40 to the network 65. If the AP 20 is capable of supporting the MU 40, the AP 20 will grant the association request (step 235). However, it may be determined that the AP 20 is not capable of supporting the MU 40. For example, as described above, the AP 20 may be operating at a maximum capacity. If it is so determined, the method 200 continues to step 230.

In step 230, the AP 20 executes a predetermined action when it cannot support the MU 40. In one embodiment, the AP 20 may free a sufficient amount of bandwidth to allow the MU 40 to associate therewith. Bandwidth may be freed if the AP 20 discontinues association with MUs that are currently consuming its bandwidth. For example, if all or most of the bandwidth of the AP 20 is being consumed by the MUs 42-48, the AP 20 may disassociate at least one of the MUs 42-48 by, for example, sending a disassociation packet to the chosen MU. The chosen MU can be selected based on any desired algorithm such as, for example, the oldest non-critical association, or the newest non-critical association. In one embodiment of the present invention, the AP 20 may disassociate all of the MUs 42-48 currently associated therewith. This may provide a maximum throughput for the MU 40 once it is connected to the network 65. Once enough bandwidth is available, the AP 20 may grant the association request of the MU 40.

In the case of an emergency call, the AP 20 accepts all traffic from the MU 40 upon association therewith. The AP 20 may then redirect the traffic received in order to facilitate completion of the emergency call. In one embodiment of the present invention, the traffic may be dropped onto a separate VLAN. Thus, the traffic from the MU 40, which is requesting emergency service, may be re-directed to a specific VLAN interface on the switch (not shown). The VLAN may have been created a priori to handle emergency traffic within the system. The VLAN interface may only be used for emergency traffic so that there is no fear of having normal traffic get in the way of emergency traffic. Thus, the emergency traffic receives a highest priority on the VLAN interface. Furthermore, using the VLAN also prevents abuse of the emergency service by an MU attempting to circumvent the security of the system. For example, even if a malicious user modifies a signal to fake an emergency call, all the data/voice traffic from that user is restricted to the VLAN. The user is prevented from getting access to the normal network. Also, a voice gateway on the VLAN may be configured to only allow calls to go to predetermined locations (e.g., emergency services lines/addresses). In another embodiment, a destination address of the traffic may be modified in order to transmit the traffic to a voice gateway. The voice gateway will only allow the call to connect if the destination address is the ESN 60. Thus, emergency calls may be quickly completed without prohibitions or delays caused by authentication requirements or a lack of bandwidth.

The present invention may be advantageous in that it allows a user of any MU to contact emergency services quickly and easily. Because the authentication information of the MU may be ignored or overridden, the user need not worry about traveling in areas covered by foreign networks. Further, the user is not required to fumble with various authentication codes or switch to an authenticated MU, and thus saves precious time. The user also need not worry about failure to reach emergency services because of a congested network.

While the present invention is advantageous to users desiring to place an emergency call, it also causes little to no inconvenience to users of other MUs on the network. When an emergency call is placed, the other users are still able to maintain a connection to the network as long as there is enough bandwidth available to support the emergency MU. Even in the event that a regular call is dropped in order to support the MU, the user of the dropped MU may likely reconnect to the network momentarily through the same or a different AP.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
receiving an association request from a first wireless device to establish an emergency connection via a wireless communications network;
analyzing a wireless bandwidth availability required to grant the request;
when the bandwidth is unavailable, terminating a wireless connection between a second wireless device and the wireless network; and
granting the request of the first device.

2. The method according to claim 1, wherein the first wireless device includes at least one of an image-based scanner, a laser-based scanner, an RFID reader, an RFID tag, a PDA, a wired network interface card, a wireless network interface card, a wireless VoIP phone and a converged network device.

3. The method according to claim 1, further comprising:
establishing the emergency connection of the first wireless device to an emergency services network.

4. The method according to claim 1, wherein the emergency connection is one of a VoIP call and a data packet transfer.

5. The method according to claim 1, wherein the association request includes data indicative of the emergency connection.

6. The method according to claim 5, further comprising:
when the data is detected, authenticating the first wireless device.

7. The method according to claim 1, after the terminating step further comprising:
dedicating a predetermined amount of the bandwidth to the first wireless device.

8. The method according to claim 1, after the analyzing step further comprising:
selecting the second wireless device from a plurality of wireless devices as a function of a duration of the wireless connection to the wireless communications network.

9. The method according to claim 1, further comprising:
dropping the emergency connection onto a virtual local area network.

10. The method according to claim 1, further comprising:
forwarding the emergency connection to a voice gateway.

11. A system, comprising:
a first wireless device transmitting an association request to establish an emergency connection to a wireless communications network; and
an access point receiving the association request and analyzing a wireless bandwidth availability required to grant the request,
wherein when the bandwidth is unavailable, the access point terminating a wireless connection between a second wireless device and the wireless network and granting the request of the first device.

12. The system according to claim 11, wherein the first wireless device includes at least one of an image-based scanner, a laser-based scanner, an RFID reader, an RFID tag, a PDA, a wired network interface card, a wireless network interface card, a wireless VoIP phone and a converged network device.

13. The system according to claim 11, wherein the access point establishes the emergency connection of the first wireless device to an emergency services network.

14. The system according to claim 11, wherein the emergency connection is one of a VoIP call and a data packet transfer.

15. The system according to claim 11, wherein the association request includes data indicative of the emergency connection.

16. The system according to claim 15, wherein the access point automatically authenticates the first wireless device after detecting the data.

17. The system according to claim 11, wherein the access point dedicates a predetermined amount of the bandwidth to the first wireless device.

18. The system according to claim 11, wherein the access point selects the second wireless device from a plurality of wireless device as a function of a duration of the wireless connection to the wireless communications network.

19. An arrangement, comprising:
a memory;
a communication arrangement receiving an association request from a first wireless device to establish an emergency connection via a wireless communications network; and
a processor analyzing a wireless bandwidth availability required to grant the request,
wherein, when the bandwidth is unavailable, the processor terminating a wireless connection between a second wireless device and the wireless network and granting the request of the first device.

20. The arrangement according to claim 19, wherein the arrangement includes at least one of an access point, an access port and a switch.
